(19) United States
(12) Patent Application Publication
(10) Pub. No.: US 2024/0070999 A1
(43) Pub. Date: Feb. 29, 2024

(54) SYSTEMS AND METHODS FOR REAL TIME DATA ANALYSIS AND CONTROLLING DEVICES REMOTELY

(71) Applicant: Epirus, Inc., Hawthome, CA (US)

(72) Inventors: Jeffery Jay LOGAN, Torrance, CA (US); Matthew Alan SKUBISZEWSKI, Torrance, CA (US); Chaise ALLEGRA, Redondo Beach, CA (US); Jason Reis Chaves, Redondo Beach, CA (US); Zachary Allen Levine, Los Angeles, CA (US); Monika Rani, Los Angeles, CA (US); Harry Bourne Marr, JR., Manhattan Beach, CA (US)

(21) Appl. No.: 17/894,958

(22) Filed: Aug. 24, 2022

(51) Int. Cl. G06T 19/00

(52) U.S. Cl. CPC G06T 19/006; G06T 19/003

(57) ABSTRACT

Systems and computer software are disclosed for AR devices having a display configured to display augmented, mixed, or virtual reality images to a user. The AR devices can comprise displaying a virtual control panel on the display, with the virtual control panel comprising a depicting of one or more targets. An output of an emission device that is intended to be directed to the one or more targets can be rendered. The AR device can also allow controlling, by the user based on input received by user interaction with the virtual control panel, one or more operations of the emission device.

### BACKGROUND

Augmented reality (AR) merges the digital and physical worlds and overlays the information to the user's field of view. Virtual reality (VR) and mixed reality (MR) involve producing virtual objects in a user's field of view. Such technologies can improve a user's experience and have been used in various industries, such as entertainment, travel, education, medical science, and others.

### SUMMARY

In one aspect, a system is disclosed comprising: an AR device having a display configured to display augmented, mixed, or virtual reality images to a user; at least one programmable processor; and a non-transitory machine-readable medium storing instructions which, when executed by the at least one programmable processor, cause the at least one programmable processor to perform operations comprising: displaying a virtual control panel on the display, the virtual control panel comprising a depicting of one or more targets; rendering an output of an emission device that is intended to be directed to the one or more targets; and controlling, by the user based on input received by user interaction with the virtual control panel, one or more operations of the emission device.

In some variations, the rendering can comprise representations of regions of directed energy from the emission device. The regions rendered can comprise a main lobe and one or more sidelobes of the directed energy. The rendering can also comprise obtaining emission device settings and/or static parameters of the emission device; calculating, with an emission simulator, a radiation field that will result from the emission device based at least on the emission device settings and/or the static parameters; and the rendering can comprise displaying an intensity of electromagnetic fields associated with the output.

In some variations, the operations of the emission device can comprise controlling the emission device to emit the output to cause an effect on the one or more targets. The controlling can be based on the system interpreting one or more hand gestures, gaze or voice commands, button presses on the AR device or a control peripheral. The rendering can be updated based on the controlling of the emission device by the user. The operations of the emission device can comprise positioning the emission device, selecting a type of output, setting a frequency of the output, setting an intensity of the output, setting a direction of the output, or setting a time to emit and steer the output to the one or more targets.

In some variations, the operations can further comprise displaying an identification of the one or more targets on the display of the AR device, wherein the emitting of the output is based on an identification of the one or more targets. The identification that is displayed can comprise one or more of a type, size, attached components, direction of movement, brand, friendly classification or un-friendly classification. The operations can further comprise obtaining map data of a region comprises the one or more targets; obtaining real-time target locations; and displaying a real-time overview on the display that comprises the map data and representations of the one or more targets. The system can also displaying coordinate information of one or more targets.

In some variations, the coordinate information can comprise one or more of latitude, longitude, or elevation of a target. The coordinate information can be obtained from GPS, RADAR, or LIDAR data. The coordinate information can also be obtained from a coordinate information of the one or more targets with respect to a scout UAV. The coordinate information can further be obtained from the coordinate information of the one or more targets with respect to the scout UAV is merged with coordinate information obtained from GPS, RADAR, or LIDAR data.

In some implementations, the system can further comprise a sensor configured to detect one or more attributes of the one or more targets; and an imaging device configured to image the one or more targets; the operations further comprising: obtaining, from the sensor, real-time sensor data and/or real-time image data; and identifying, from the real-time sensor data and/or the real-time image data, the target. The detected one or more attributes of the one or more targets can comprise presence, environmental data at or around the one or more targets, velocity, acceleration, or coordinates. The one or more targets can comprise imaging one or more of: the one or more targets itself, attached components, or emissions.

In some implementations, the system can identify information about the one or more targets based on the sensor data, with the information comprising one or more of: presence, velocity, acceleration, coordinates, route navigated, satellite source, range from the emission device, environmental data around the one or more targets, temperature, or field of view (FOV). The system can also identify information about the one or more targets based on the image data, with the information comprising one or more of: identifying a type of target, identifying one or more characteristics, identifying one or more devices or systems associated with the one or more targets, battery information, power information, type, brand, size, or shape.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also contemplated that may include one or more processors and one or more memories coupled to the one or more processors. A memory, which can include a computer-readable storage medium, may include, encode, store, or the like, one or more programs that cause one or more processors to perform one or more of the operations described herein. Computer implemented methods consistent with one or more implementations of the current subject matter can be implemented by one or more data processors residing in a single computing system or across multiple computing systems. Such multiple computing systems can be connected and can exchange data and/or commands or other instructions or the like via one or more connections, including but not limited to a connection over a network (e.g., the internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to particular implementations, it should be readily understood that such features are not intended to be limiting. The claims that follow this disclosure are intended to define the scope of the protected subject matter.

### BRIEF DESCRIPTION OF THE DRAWINGS

FIG. 1 illustrates a system utilizing an AR device to display information about an emission device in accordance with certain aspects of the present disclosure.

FIG. 2 illustrates a system utilizing an AR device to control an emission device in accordance with certain aspects of the present disclosure.

FIG. 3 illustrates an AR device and a virtual control panel interfaced with a controller in accordance with certain aspects of the present disclosure.

FIG. 4 illustrates the software architecture of the controller in accordance with certain aspects of the present disclosure.

FIG. 5 illustrates an exemplary AR display of target identification and target information in accordance with certain aspects of the present disclosure.

FIG. 6 illustrates an exemplary AR display of a radiation emission pattern and identified targets in accordance with certain aspects of the present disclosure.

FIG. 7 illustrates a graphical user interface (GUI) of the AR device displaying an augmented view of the field to the user as a virtual control panel in accordance with certain aspects of the present disclosure.

FIG. 8 illustrates an exemplary GUI of the AR device displaying control options and target information in accordance with certain aspects of the present disclosure.

FIG. 9 illustrates an exemplary GUI of the AR device displaying an overview, control options, and target information in accordance with certain aspects of the present disclosure.

FIGS. 10A-10D illustrate controlling an emission device with an AR device to direct radiation to targets in accordance with certain aspects of the present disclosure.

FIG. 11 is a simplified flow diagram depicting displaying information at an AR device and controlling an emission device, in accordance with certain aspects of the present application.

### DETAILED DESCRIPTION

The present disclosure provides, among other things, systems, methods, and computer programs that utilize augmented reality, mixed reality, and/or virtual reality technology to facilitate the display of graphics and information regarding, and/or control of, hardware configured to direct energy from an emission device to one or more targets. Such control can, for example, be more responsive to user input, allow a user to account for a real-time environment around the controlled device, targets of the controlled device, or the user themself, or facilitate real-time control with continuously updated information presented to the user about the controlled device, targets, etc.

Generally, augmented reality refers to displaying virtual information or images overlayed onto the real world seen by the user through a display device, such as glasses, goggles, a heads-up display (HUD), teleprompters, or the like. Mixed reality generally allows real-world actions to affect the virtual elements. For example, mixed reality can comprise changing a graphic or information based on eye or hand motions, or virtual graphics/information changing based on a user's location. Virtual reality generally refers to an immersive environment where all of the displayed features are virtual, including the environment perceived by the user.

As used herein, the terms augmented reality (AR), mixed reality (MR), and virtual reality (VR) are collectively referred to herein (for shorthand purposes only) as augmented reality. However, the present disclosure contemplates that any of the described features relating to AR may be identically or similarly used in an MR or VR environment. For example, embodiments that comprise a depicting of directed energy can be realized in a pure AR mode (over the real-world surroundings), an MR mode (where the energy is depicted against a real-world backdrop and its appearance may change based on user movement, and/or a VR mode (where the energy is depicted in an entirely virtual environment).

As used herein, the term “emission device” can comprise a source of directed energy such as a microwave or other electromagnetic radiation emitter, lasers, radio detection and ranging (RADAR), sound, particles (ions/plasma/fluids), etc. Specific examples of emission devices can comprise, high power microwave (HPM) systems, directed energy weapons, radio frequency (RF) systems, lasers for manufacturing, etc.

As used herein, the term “target” can comprise any object towards which energy from the emission device is directed. Specific examples of targets can comprise unmanned aerial vehicles (UAVs), surfaces to be cut or melted as part of a manufacturing process, etc.

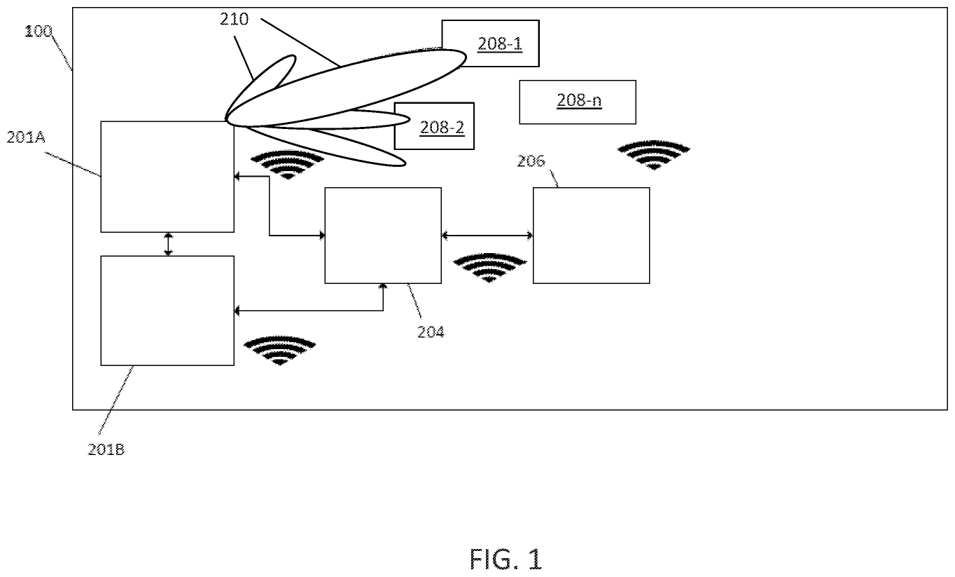

FIG. 1 illustrates a system utilizing an AR device 204 to display information about an emission device in accordance with certain aspects of the present disclosure. More particularly, FIG. 1 shows a system 100 depicting an exemplary configuration of various devices in communication with AR device 204. In some embodiments, system 100 comprises one or more emission devices 201A, control device 201B, and AR device 204. FIG. 1 also shows a simplified depiction of directed energy emitted from emission devices 201A in the form of lobes 210 that may be directed at one or more targets, as explained further herein. The system can optionally comprise sensors 206 (e.g., optical sensors, environmental sensors, RADAR, laser rangefinders, etc.) that may facilitate displaying the AR environment or other display information, facilitate target identification and/or tracking, etc. FIG. 1 also depicts examples of targets 208-1, 208-2, . . . , 208-n. In some embodiments, the targets 208-1, 208-2, . . . , 208-n can comprise any number (n) of unmanned aerial vehicles (UAV), with multiple UAVs also referred to herein as a swarm of UAVs. In some other embodiments, the targets 208-1, 208-2, . . . , 208-n can comprise objects on the manufacturing floor.

The emission device 201A can be configured to emit radiation, such as, for example, electromagnetic radiation or ultrasound radiation. The emission device 201A may comprise radiofrequency (RF) emitters, microwave emitters, lasers, ultrasonic emitters, sound emitters, etc. Control device 201B can comprise signal devices (e.g., lights, transponders, alarms, etc.), switches and other devices to provide power to the emission device, positional control devices to control the position, azimuth and elevation angles of the emission device (e.g., devices that turn or otherwise steer the emitter), etc. The emission device 201A, the control device 201B and the AR device 204 can be interconnected via wired and/or wireless connections. Communication between the emission device 201A, the control device 201B and the AR device 204 can be achieved by integrated communication devices or one or more external processors or a server executing a software program.

The AR device 204 can comprise a display device to present the AR information as well as real-world information. In some implementations, the display device can comprise a liquid crystal display, a light emitting diode display, a plasma display, a projection display, or a holographic projector. In various implementations, the AR device 204 can comprise a head mounted display, such as, for example, near eye display, glasses or goggles. In various implementations, the AR device 204 can comprise a depicting of a mobile device. The AR device 204 can be configured. In addition to the display device, the AR device 204 can also comprise additional computers, cables, control peripherals (e.g., joysticks, hand sensors, body motion/location sensors, etc.), and/or other devices that are configured to generate graphics and/or other virtual information for display.

The AR device 204 can use one or more electronic processors and one or more application programs to connect with emission device 201A and other control device 201B. The AR device 204 can be configured to communicate with one or more emission device 201A and other control device 201B via wired or wireless network. The wired network may comprise traditional ethernet, local area networks (LANs), fiber-optic cables, etc. Wireless networks can comprise cellular, wireless application protocol (WAP), wireless fidelity access point (Wi-Fi), near filed connection (NFC), etc.

In some embodiments, the system can comprise one or more sensors 206 configured to detect one or more attributes of targets 208-1, 108-2, . . . , 208-n. The one or more sensors 206 can comprise imaging devices configured to image targets 208-1, 108-2, . . . , 208-n. The system 100 can be configured to obtain real-time sensor data and/or obtain real-time image data from the sensor 206. The system 100 can comprise electronic processors configured to identify the one or more targets, based on the sensor data.

Sensors 206 can be configured to provide information to the AR device 204 regarding targets 208-1, 208-2, . . . . , 208-n in sufficient real time (e.g., within a few seconds, a few milliseconds, a few microseconds, etc.). The sensors 206 may comprise electro/optical, infrared, radio, vibrational, positional, temperature, radio detection and ranging (RADAR), etc. The sensors 206 may connect to the AR device 204 using a wired or wireless connection. The user of the AR device 204 can view information received from the sensors 206 on the display of the AR device 204 using one or more control devices associated with the AR device 204 cause the system 100 to perform a function. For example, the user can use hand gestures, voice commands and/or physical controls (e.g., activate a button or move a joystick) associated with the AR device 204 to cause the emission device 201A to direct a radiation towards one or more of the targets 208-1, 208-2, . . . . , 208-n.

Sensed attributes of the targets 208-1, 108-2, . . . , 208-n can comprise presence (e.g., detecting that the target is there), environmental data at or around the one or more targets, velocity, acceleration, coordinates, etc. Imaging of the targets can comprise imaging the targets themselves, attached components, emissions, etc.

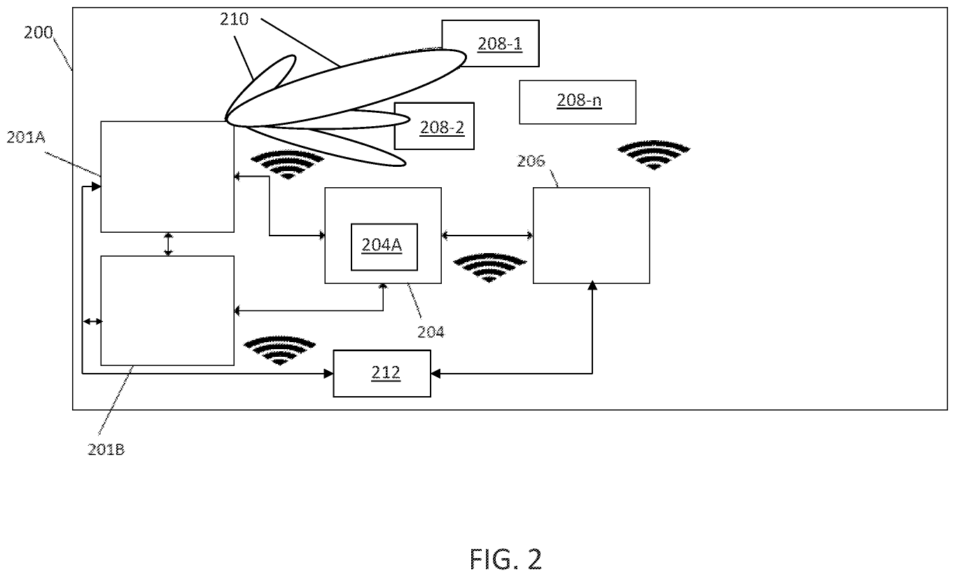

In some implementations, one or more electronic processors associated with the sensors 206 can be configured to execute a computer algorithm/process/software program to detect and identify attributes of targets 208-1, 108-2, . . . , 208-n. Such detection can comprise determining and providing real time information related to the targets. Such information can be utilized to update status information of the targets as displayed by the AR device 204. Based on the information displayed on the display device, the user can control (e.g., using a hand gestures) options on a virtual control panel 204A, depicted in FIG. 2, displayed on the display to retrieve or present status information of the emission device 201A, targets 208-1, 208-2, . . . , 208-n, etc.

The system can also identify information about the targets 208-1, 108-2, . . . , 208-n based on the sensor data. The information can comprise presence, velocity, acceleration, coordinates, route navigated, satellite source, range from the emission device, environmental data around the one or more targets, temperature, field of view (FOV), etc.

The system can also identify information about the targets 208-1, 108-2, . . . , 208-n based on the image data. The information can comprise identifying the type of the target (e.g., if one or more targets is a UAV), identifying one or more characteristics of the targets, identifying one or more devices (e.g., cameras) or systems associated with the target, battery information, power information, type, brand, size, shape, etc.

Sensors 206 are optional, and thus not necessarily physically included in all embodiments. For example, a particular system, which may not have sensors of its own, can receive sensor data over internet or other communications channels. In other embodiments, the system may not comprise sensors 206 or utilize sensor data. For example, such systems may rely on visual guidance by a user to direct the emission device rather than relying on automatic target tracking facilitated by sensors.

Information about targets 208-1, 208-2, . . . . , 208-n may comprise identification of target to determine the type of target for example, a commercial flight, UAV, bird, or any other flying object, shape and color, dimensions, any attachment associated to the target, specification, directions, coordinates, speed, associated relationship of the target with the user. The associated relationship of the target can be defined as a friendly or unfriendly target. Friendly targets are the ones that may not appear to be a potential risk to the user or may belong to the user domain. In contrast, unfriendly targets are the ones that may not appear to belong to the user or may appear to be a potential risk for the user.

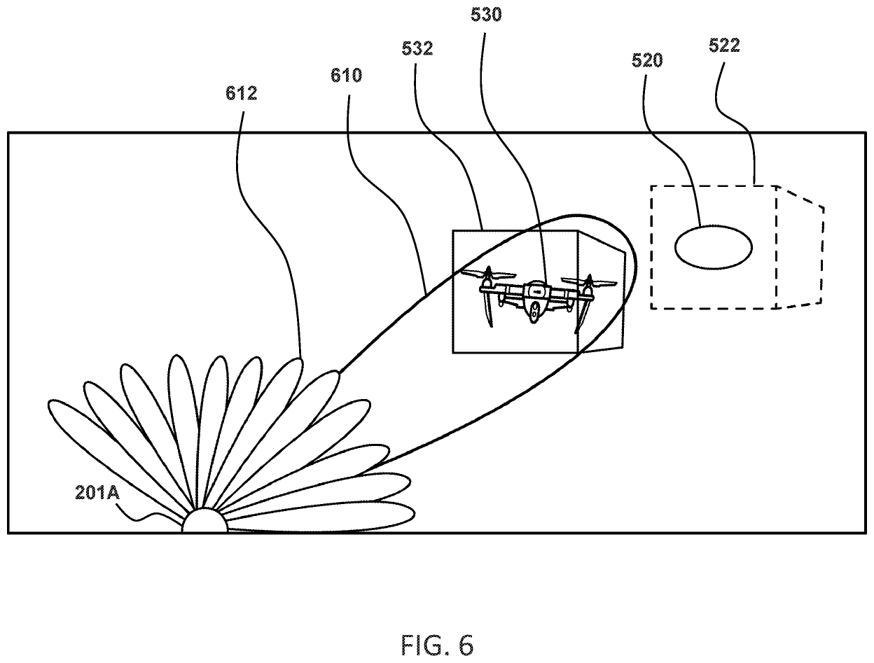

FIG. 2 illustrates a system utilizing an AR device to control an emission device in accordance with certain aspects of the present disclosure. FIG. 2 shows a system 200 depicting an exemplary virtual control panel 204A generated by AR device 204 having a display configured to display augmented, mixed, or virtual reality images to a user. In this way, embodiments of system 200 can be configured to display a virtual control panel on the display, the virtual control panel comprising a depicting of one or more targets 208-1, 208-2, . . . . , 208-n. In some embodiments, the AR device 204 can also provide the user with information related to the targets on the display of the AR device 204. The user may utilize the information about the targets to control, via the AR device 204, the one or more emission device 201 to take one or more actions. In some implementations, the output of emission device that is intended to be (or is currently being) directed to the one or more targets can be rendered at the display. Additional details of such renderings are provided herein, for example with reference to FIGS. 6, 7, and 10.

Some embodiments of AR device 204 can comprise virtual control panel 204A that may display one or more control options to activate and deactivate emission device 201A and/or other control device 201B. The AR device 204 can communicate with sensors 206 via a wired or wireless connection. The situation awareness sensors 206 can sense and receive target information using software or program embedded in the sensors and can provide information regarding targets 208-1, 208-2, . . . . , 208-n to the AR device 204 and/or hardware controller 212. Information regarding targets 208-1, 208-2, . . . . , 208-n may be provided to the AR device 204 via wired or wireless communication. The display of the AR device 204 can display target information alerts from the situation awareness sensors 206 to the user. Based on the information displayed on the display of the AR device 204 user can activate the control panel menu on the control panel 204A using hand gestures, voice commands, pressing any switch on the display of the AR device 204, etc.

The control panel 204A displays one or more control functions to display the real-time status of the emission device 201A, other control device 201B, targets 208-1, 208-2, . . . , 208-n, etc. The real-time status of the emission device 201A and control device 201B may comprise, charging level, operational/power status, frequency range, directional information, positional information, elevation, configuration of control switches, beam intensity level, beam positions, etc.

In some implementations, system 200 can comprise a hardware controller 212 that can receive information from connected devices such as sensor 206, control device 201B, emission device 201A, AR device 204, etc. Hardware controller 212 can process the information to provides one or more commands to the connected devices. In another implementation, hardware controller 212 can process information from the connected devices, generate control information and provide such control information to the user on the AR device 204.

The system can also allow a user to control, based on input received by user interaction with the virtual control panel 204A, one or more operations of the emission device 201A. For example, some operations can comprise controlling the emission device to emit the output to deactivate the targets. In various embodiments, the controlling of the emission device can be based on the system interpreting one or more hand gestures, gaze or voice commands, button presses on the AR device or a control peripheral, etc. As some specific examples, optical sensors on goggles or a headset can be used to detect and interpret eye-movement which can then be translated into instructions for the system to display information or control a device. Other peripherals such as joysticks, controllers, keyboards, gloves with sensors or motion detection hardware, etc. can also be utilized to provide input that can be interpreted as commands by the system. In some embodiments, generating control instructions can comprise positioning the emission device, selecting a type of output (e.g., a frequency band such as microwave, infrared, etc., laser wavelength band such as UV, DUV, EUV, etc.), setting a frequency of the output, setting an intensity of the output, setting a direction of the output, or setting a time to emit and steer the output to the one or more targets.

One example of how a virtual control panel 204A can be utilized to control the emission device 201A can comprise AR device 204 performing eye tracking and/or hand movement tracking to allow the AR device 204 to interpret eye/hand movements as interacting with virtual elements. Some examples can comprise moving slider(s) that represent the direction and/or vertical angle of the emission device 201A, detecting a point the user is looking at in the virtual or augmented space and using that point as an indication of a desired point of radiation delivery, determining a similar point based on hand/eye selected targets in the augmented environment, etc. The manipulation/selection of such virtual elements can then be converted into a command for hardware controller 212 (e.g., turn the emission device 201A 10 degrees, orient the emission device 201A to direct radiation to the center of the selected group of targets, etc.). The controller can then convert this command into control instructions that can be communicated to emission device 201A. For example, the instruction can be to activate a particular servo at the emission device to execute the requested 10 degree turn, or to modify the frequency, power, phase, or other settings for one or more antennas of the emission device 201A to allow radiation to be emitted that meets the requested parameters. In some embodiments, determining the requested radiation output can comprise utilization of lookup tables or other already existing calculations that can be accessed to provide needed instructions and/or used to render the expected output emission device 201A. In other embodiments, calculations/simulations can be performed responsive to the user's request in order to determine the needed adjustments to the emission device 201A and/or any depictions of simulated radiation output. In embodiments where the user is provided with a status of the emission device 201A, the user may see the rendering or other depiction of emission device 201A after, or during, execution of the instruction by the physical emission device 201A.

In another variation, a user of the AR device 204, can activate and/or control emission device 201A. The user can use various functions using virtual control panel 204A to activate the emission device 201A or other control device 201B to affect one or more targets 208-1, 208-2, . . . . , 208-n. In a manufacturing environment, the effect on the target can comprise cutting, welding, melting, or any other manufacturing process. In some implementations, the radiation from the emission device 201A can deactivate one or more targets 208-1, 208-2, . . . . , 208-n.

As used herein, the term “deactivate” means to cause the target to effectively cease one or more operations. For example, deactivating a target can comprise interfering with or overloading one or more circuits in the target to cause it to land or cease a desired operation (e.g., surveillance, navigation, weapon use, propulsion, etc.). Deactivation may comprise, but not necessarily cause, physical damage to the target.

In one of the implementations, the user can provide control commands using the virtual control panel 204A of the AR device 204 to emit radiation from emission device 201A to deactivate targets 208-1, 208-2, . . . . , 208-n. The control commands can be processed and implemented by hardware controller 212 to control direction and emission from emission device 201A. For example, the AR device 204 can provide various control functions to position/steer the emission device 201A so that the emission device 201A emits radiation to any of (or any combination of) targets 208-1, 208-2, . . . . , 208-n. In some implementations, hardware controller 212 can generate the available control commands based on the information received from the sensors 206, other control device 201B, and emission device 201A. The hardware controller 212 can then provide the control options on the virtual control panel 204A of the AR device 204 for a user to control and position/steer emission device 201A and any other control device 201B to deactivate the targets 208-1, 208-2, 208-n.

The frequency (e.g., frequency in Hz) and direction of the radiation from emission device 201A can be controlled by a user from the virtual control panel 204A of the AR device 204. For example, as seen in FIG. 2, radiation from the emission device 201A can be steered in various directions depending on the speed, position of targets 208-1, 208-2, and 208-n. These and other features are further explained later in the specification, supporting other figures.

In some embodiments, the display of the AR device 204 can display renderings of radiation emitting from the emission device 201A, in which the radiation may not be visible to the human eye. Sensors 206 can comprise microwave cameras or other detectors/cameras that are sensitive in the wavelength/frequency range of emission device 201A can image the actual emissions of the emission device and provide imaging data for rendering at AR device 204.

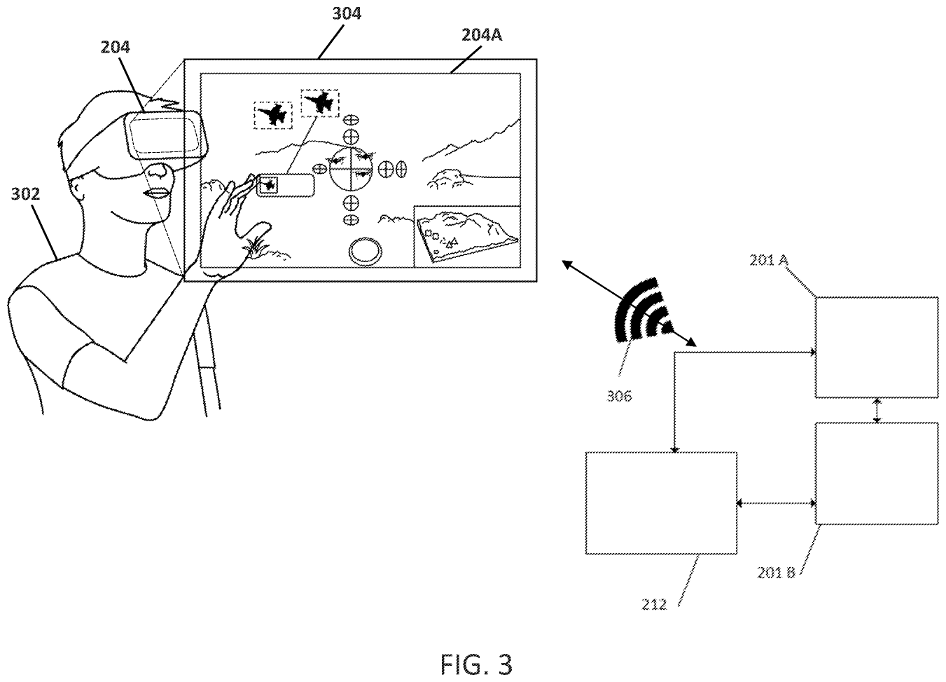

FIG. 3 illustrates an AR device and a virtual control panel 204A interfaced with a controller. More particularly, FIG. 3 shows an exemplary implementation of a user 302 and AR device 204 using the virtual control panel 204A to communicate (e.g., by wireless communication link 306) with emission device 201A, other control device 201B, and hardware controller 212.

The AR device 204 can be configured to display one or more control applications, control information, status information, characteristic information, or information related to emission device 201A and other control device 201B on a GUI displayed on display 304. AR device 204 can generate, in a virtual space, display 304 that can comprise (e.g., in one part of the user's field of view, virtual control panel 204A. As shown in FIG. 3, the virtual control panel 204A can comprise multiple sections that can display different information relating to emission device 201A, the targets, etc. Information displayed on display 304 may be accessed using applications, menus, and associated hardware/software to allow the user to interact with and/or control operations of emission device 201A, as well as access/manipulate information via AR device 204. Further details of various embodiments of the virtual control panel 204A are discussed throughout the present disclosure.

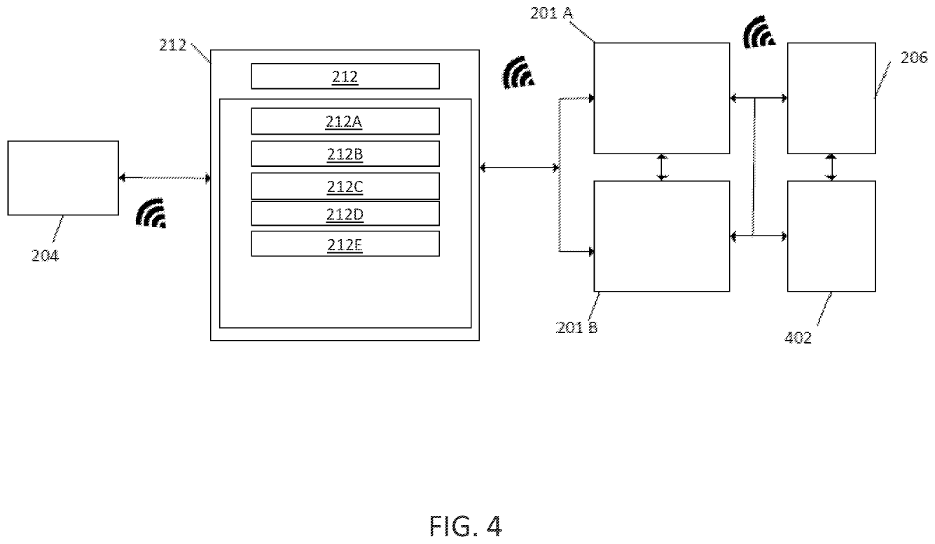

FIG. 4 illustrates the software architecture of the hardware controller 212 in accordance with certain aspects of the present disclosure. FIG. 4 depicts simplified views of AR device 204, hardware controller 212, emission device 201A, other control device 201B, sensors 206, and an imaging device 402. In some embodiments, imaging device 402 can capture images of the targets while sensors 206 can capture sensor data of the targets. In some embodiments, the imaging device 402 and the sensors 206 can be integrated in a device/unit. The information captured from the imaging device 402 and sensors 206, along with the current status of emission device 201A and other control device 201B, can be processed in the hardware controller 212 or other computing system. The controller or other computing system can comprise databases or repositories accessed using one or more software programs. The controller can comprise, or have access to, software modules such as databases related to beamforms 212A, drone resources 212B, GPS information 212C, sensor information 212D, or imaging database 212E. In some other embodiments, where the emission device 201A is configured as a manufacturing laser, the databases can have information related to objects and systems in the manufacturing facility. These and different combinations of databases can be employed to process, for example, the real-time information received from any of emission device 201A, other control device 201B, sensors 206, or imaging device 402. This processing can comprise identifying the target (UAVs, airplanes, birds, objects and systems in a manufacturing facility, etc.), characteristic information (type of target UAV, friendly or non-friendly, size, direction, speed, altitude, coordinate information, brand information, color, characterization of the objects and systems in a manufacturing facility, etc.), beam information (what type of emission is required to address the target, intensity and timing of radiation emission, steering and positioning coordinates, activation status, etc.). The processed information from hardware controller 212 can then be provided to AR device 204 to display graphics and control options on virtual control panel 204A to allow the user to view and control operations of emission device 201A.

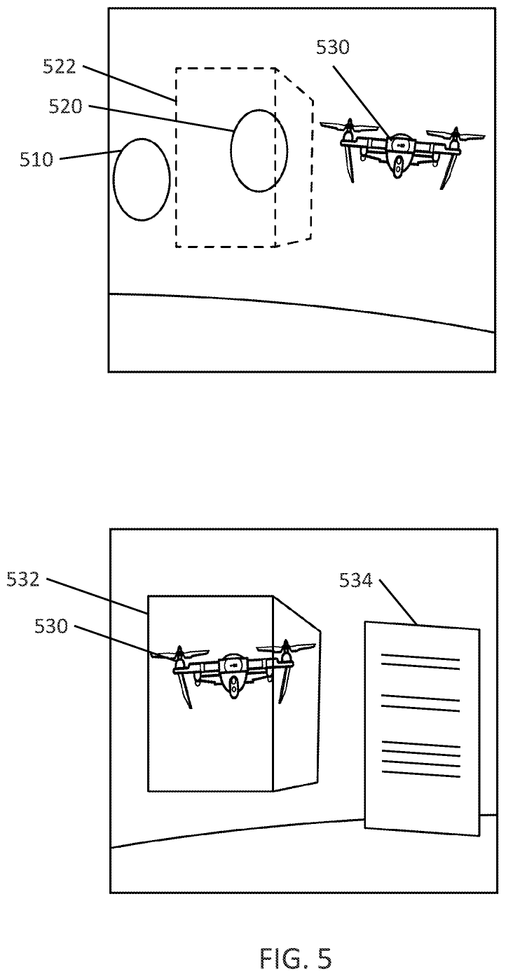

FIG. 5 illustrates an exemplary AR display of target identification and target information. Imaging device 402 and sensors 206 (as shown, e.g., in FIG. 4) can collect image information and sensor data, which can be processed by the hardware controller 212 to determine whether a target is, for example, a friendly UAV or a non-friendly UAV. The identification process may use various software components, command scripts, UAVs library/database, GPS coordinates, image recognition applications, etc., to identify and classify the characteristics of UAVs. The information about the targets can then be provided to the user of AR device 204. In some embodiments, the AR device and its applications can receive RADAR or other sensor data to update the target positions over time.

In some implementations, information about the targets can be collected by a scout UAV. The scout UAV can collect information about targets in its vicinity and transmit the collected information along with the location of the scout UAV to the hardware controller 212 or other computing system associated with the emission device 201A. The hardware controller 212 or other computing system can combine the information from the scout UAV with data from other sensors (e.g., sensors 206), imaging device (e.g., imaging device 402) and/or associated RADAR data to increase the precision of determining the location of the targets. The location of the targets and/or the location of the scout UAV can be displayed on the AR device 204. The scout UAV can be designated as a friendly target that is to be unaffected by the emission from the emission device 201A.

The upper panel in FIG. 5 depicts identifying potential targets. Three potential targets are shown where the two potential targets (510, 520) on the left represent exemplary aerial elements such as birds, friendly aircraft, friendly drones, etc. The leftmost potential target 510 is depicted as unidentified. The potential target 520 in the center of the group is depicted as, for example, a friendly aerial element. To aid the user, some embodiments may comprise displaying a graphical indicator 522 that shows the potential target 520 as a friendly, or otherwise an element that should not receive direct energy from the emission device. In the depicted example, the graphical indicator 522 is depicted as a box. However, any suitable graphical indicia can be utilized to indicate the classification of the potential target 520. For example, targets 510 and 520 may be displayed in different colors based on their classification. Arrows, text or other graphics may be displayed over the targets 510 and 520 based on their classification. The rightmost aerial element is depicted as a target 530 that is an identified drone but does not currently show a friendly/unfriendly graphical indicator.

The lower panel depicts graphical output that can be displayed to a user showing identified target 530 as a drone but with the addition of a second graphical indicator 532. Additionally, certain embodiments can comprise automatically, or responsive to a user command, target data 534 that can provide information about the target, such as, identification, position, vector, etc.

FIG. 6 illustrates an exemplary AR display of a radiation emission pattern and identified targets. As shown in FIG. 6, some embodiments can comprise the system being configured to render regions of directed energy from the emission device 201A.

In some embodiments, to perform the rendering, the system can obtain emission device settings that may be set by a user (e.g., via virtual control panel 204A), static parameters of the emission device 201A, power systems, etc., environmental conditions (e.g., temperature, humidity, cloud cover, etc.). The emission device settings, static parameters, environmental conditions, etc. can be input to an emission simulator that calculates the radiation field that will result from the emission device. The calculations regarding the radiation field can comprise the radiation pattern, the elevation and azimuth angles of the radiation field, the radiated power, etc. The emission simulator may be executed by an electronic processing system associated with the emission device 201A or the AR device 204. Such simulations can be based on power/direction of antenna output and the resulting electromagnetic fields. In some embodiments, the system can render 2D regions or 3D surfaces of a given intensity, deactivation effectiveness/probability, etc. The emission simulator can also optionally provide electromagnetic field vectors as the orientation of such at the target may be related to the effectiveness of the electromagnetic field in affecting target circuitry or operations.

In various implementations, the user can indicate one or more targets or regions in the surrounding environment that should be avoided. The emission simulator can calculate the radiation field that would reduce the electrical field strength at the one or more targets or regions indicated by the user to a level that doesn't cause any harm. For example, the emission simulator can generate a radiation field that has nulls in the one or more targets or regions indicated by the user. In various implementations, the user can provide input regarding the frequency composition of the emitted radiation, the waveform parameters (e.g., pulse width, pulse duration, duty cycle, etc.) of the emitted radiation using the AR device 204. In some implementations, the AR device 204 or an electronic processing system associated with the emission device 201A can employ computer vision algorithms along with other sensor data to classify one or more targets. The classification data can inform the emission device 201A can aid in the generating the radiation pattern that would best engage with the target.

In embodiments where emission device 201A is an RF emitter, certain renderings can comprise depicting specific structures of radiation emission from the emission device 201A. Such regions rendered can comprise a main lobe and one or more sidelobes of the directed energy. For example, main lobe 610 can be a region where the emitted radiation or directed energy is generally largest. Similarly, sidelobes 612 can represent regions where significant radiation can be emitted but may not be used for target deactivation or other primary application of the emission device 201A. In contrast, such sidelobes 612 can optionally indicate regions to be avoided, such as to avoid inadvertently affecting friendly aerial elements. Although not depicted, the rendered regions can comprise gaps between different sidelobes or the main lobe 610 and the sidelobes corresponding to nulls in the radiation pattern.

In some embodiments, the rendering can be updated based on the controlling of the emission device by the user. For example, based on steering the emission device, the depiction of the radiation pattern may change (e.g., from side-on to more end-on). In other embodiments, the size, shape, intensity, etc. can be updated based on the delivered or planned radiation emission. For example, if the frequency, power or waveform characteristics of the RF signal generated by the emission device 201A is adjusted to change the shape of the radiation pattern, the intensity of the radiation may also change in the graphically updated rendering for the user.

FIG. 6 illustrates one example of a radiation beam emitted from the emission device 201A to deactivate target (e.g., target 530). Such an example rendering can be generated at the display device for viewing by a user. As shown, the main lobe 610 and sidelobes 612 represent radiation with one graphical indicator showing a target 530 (with second graphical indicator 532) where target 530 is to be affected by the emitted radiation, and another potential target 520 with graphical indicator 522 indicating that it is to be avoided and thus not affected by the emitted radiation.

In some embodiments, where there may be a swarm of targets such as a swarm of UAVs, the emitter device can be controlled such that the radiation tracks the central region of the swarm based on the average position of the various targets in the swarm. In one or more embodiments, the swarm tracking of targets can be adjusted to account for targets that are spaced farther from the central region of the swarm, for example, by orienting the radiation pattern to envelop as many of the targets as possible even if some targets are outside the radiation pattern.

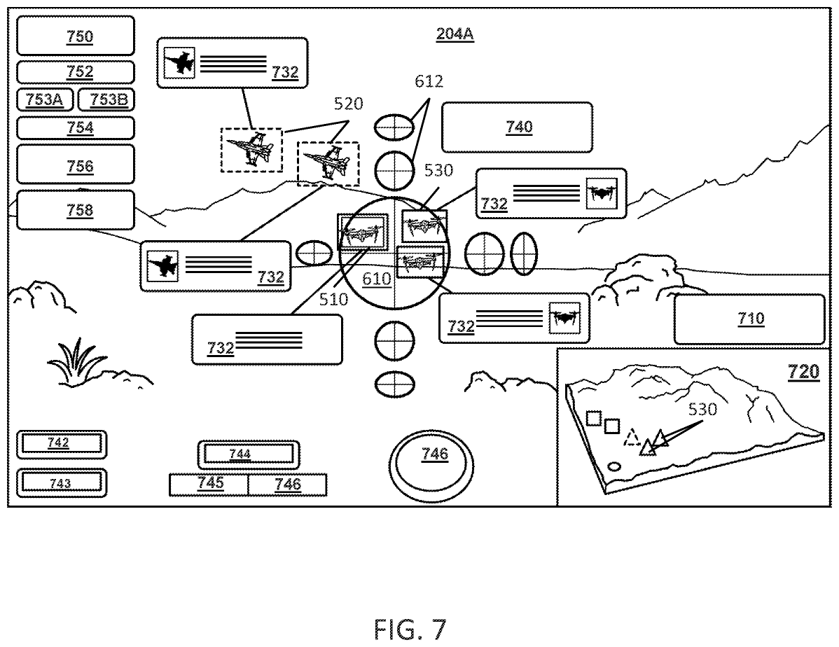

FIG. 7 illustrates a graphical user interface (GUI) of the AR device displaying an augmented view of the field to the user as a virtual control panel 204A. The features described herein can be combined in numerous ways across many embodiments to provide an intuitive, dynamic, and accurate display of the status of the emission device, potential targets 510, 520, 530, and potential directed energy from the emission device. The directed energy from the emission device can comprise a main lobe 610 and sidelobes 612 as discussed above with reference to FIG. 6. In the embodiment of a virtual control panel 204A depicted in the example of FIG. 7, such features can be combined to provide a view of a surrounding environment where a user can leverage the information displayed at the display device to direct a specific radiation pattern to selected targets. This can be done while the user remains aware of the local environment (around the emission device) by the system displaying or otherwise making available the real environment (or virtual replication of such in a VR embodiment).

Some embodiments may comprise a real-time overview 720 of a region where the emission device, targets, friendlies, or other points of interest may be depicted. As such the system can be configured to obtain map data of a region that comprises one or more targets 530 and obtain real-time target locations. The system can then display a real-time overview 720 on the display that can comprise the map data and representations of the one or more targets. An example of a real-time overview is depicted in the lower right corner of the virtual control panel. In some implementations, map command prompts 710 can be displayed and comprise indicating that the user can zoom (e.g., with a pinching action by a user), rotate, etc. the real-time overview 720.

As shown in FIG. 7, some embodiments can comprise displaying an identification 732 of the targets (e.g., unidentified target 510, friendly 520, or identified target 530) on the display of the AR device. The emitting of the output can be based on an identification of the targets. For example, the output radiation can be not allowed (or require specific overrides) if a friendly element/target is in the radiation area. To aid the user, some embodiments can display identification such as a type, size, attached components, direction of movement, brand, friendly classification, or un-friendly classification. The system can also display coordinate information of one or more targets, for example, latitude, longitude, or elevation of targets. In various embodiments, the coordinate information can be obtained from GPS, RADAR, or LIDAR data. In some embodiments, the identification displayed can comprise partial identification, e.g., if such identification is ongoing or only some information is known.

As seen in FIG. 7, the virtual control panel 204A can display information related to emission device 201A. For example, virtual depictions of the main lobe 610 and sidelobe(s) 612 can be depicted, as well as any computed null zones. Beam command prompts 740 can be displayed indicating options available to a user for controlling the beam, such as placing the beam, sidelobes, or null zones with hand gestures, etc. Control options, depicted as virtual buttons/status fields, for the beam can comprise adding nulls 742, placing a beam, 743, requesting fire 744, showing a firing status approved 745 or denied 746, and a fire button 746.

As also shown in FIG. 7, some embodiments can comprise any of the following features, in any combination. A button 750 enabling gestures to activate one or more operations, button 752 to display target information, button 753A to increase or button 753B to decrease displayed font sizes, button 754 to show available external devices or unit status, button 756 to enable/disable beam data from the emission device, or button 758 to enable and disable null data (depicting beam nulls). It is noted that the exemplary virtual control panel 204A is not limited to the specific control operations, information, data, and buttons depicted in FIG. 7.

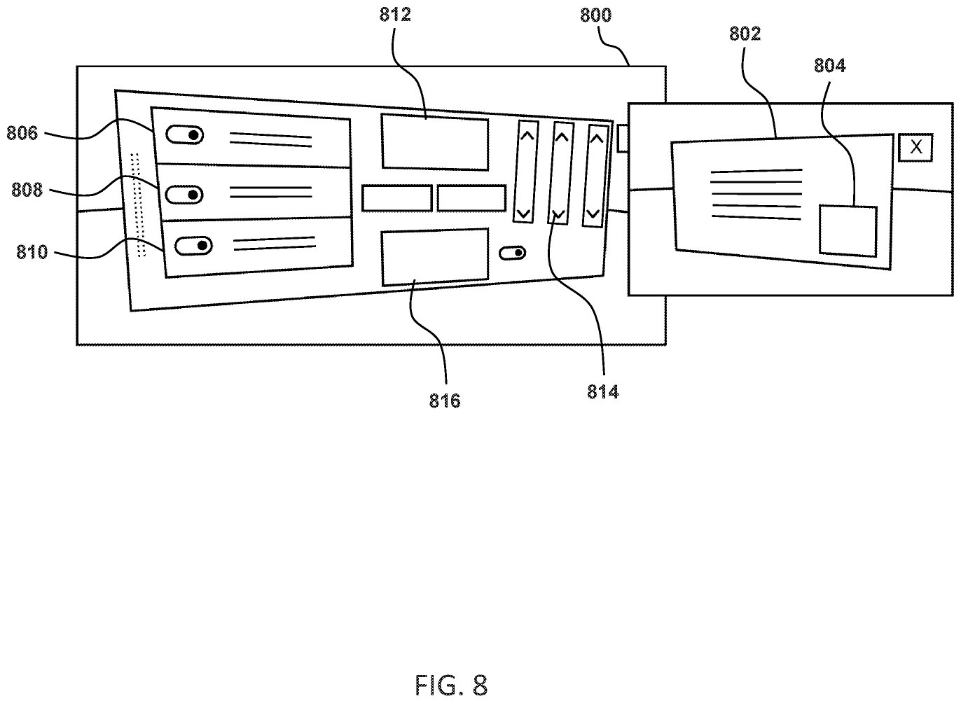

FIG. 8 illustrates an exemplary GUI 800 of the AR device 204 displaying control options and target information. The example GUI 800 in FIG. 8 can display information on the display of the AR device 204 as part of virtual control panel 204A. The information can be related to target data 802, an option 804 to access the GPS information or map data to access details of targets, an option 806 to outline targets, an option 808 to display characteristic information of targets, or an option 810 to display regions of radiation beam from the emission device.

As indicated by the example toggles, buttons, etc., such information and control options can be activated by user's movements, hand gestures, buttons displayed on the AR device 204, or even voice commands to activate options presented at the virtual control panel 204A. In some embodiments, the GUI 800 can be modifiable or able to be manipulated such as to be scalable, rotatable, moveable, or lockable. The system can dynamically modify any of the disclosed GUIs to provide real-time information, for example based on changing target conditions. The system can be configured to allow users to toggle back and forth to access information related to various devices used in the field. In another implementation, hardware controller 212 can also provide and display information at the AR device 204 that a user may rely on when providing commands for any of the connected devices.

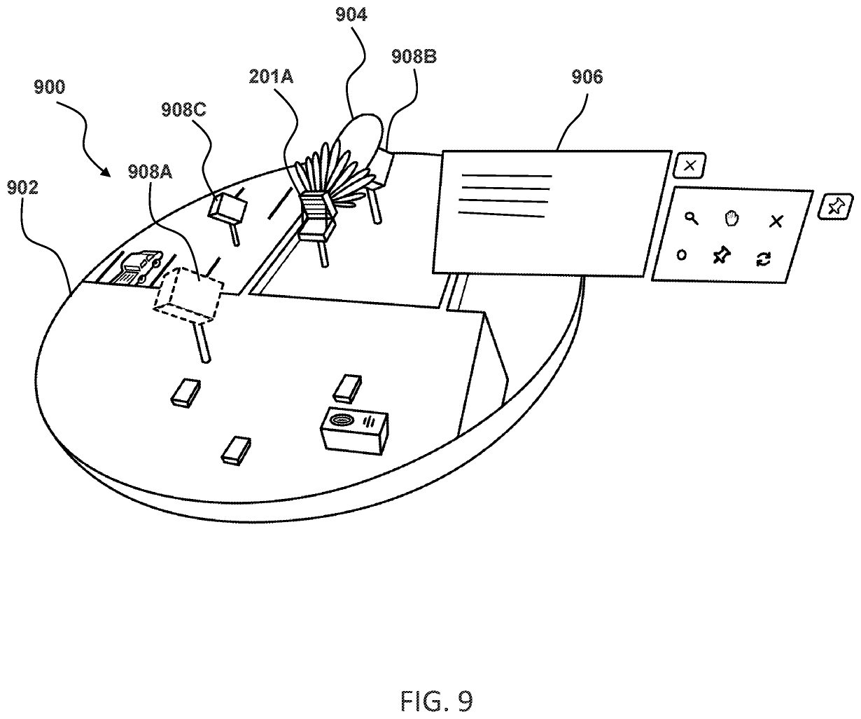

FIG. 9 illustrates an exemplary GUI 900 of the AR device displaying an overview, control options, and target information. In some embodiments, the AR device can display a rendering of a field 902 (similar to overview 720 in FIG. 7) that can comprise, emission device 201A, and/or a rendering of radiation output 904, map and GPS coordinate information 906 for the emission device 201A, and/or information related to targets 908A, 908B, 908C. In some embodiments, the map information displayed on the display of the AR device 204 can be controlled by the user to move, rotate, scale, lock, zoom, traverse, etc.

In this example, AR device 204 can display the emission device 201A, a detected target 908A that is to be unaffected by the emitted radiation and a target 908B that is to be affected by the emitted radiation. The AR device 204 can also render the radiation output 904 and depict it steered in the direction of the target 908B to cause an effect.

Upon detecting the target 908B as non-friendly, the user can activate one or more control commands from the display of the AR device 204 to perform actions with the emission device 201A or other external devices. As described herein, based on the control commands displayed on the display of the AR device 204, the user can control and operate the emission device 201A to release radiation output to cause an effect on the target 908B.

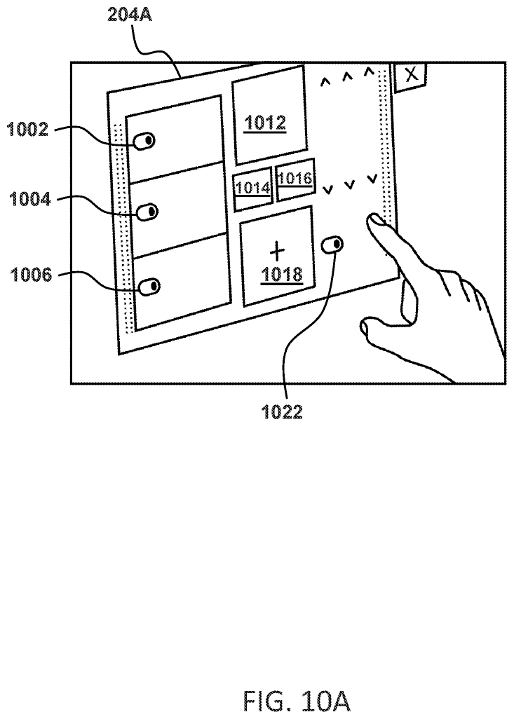

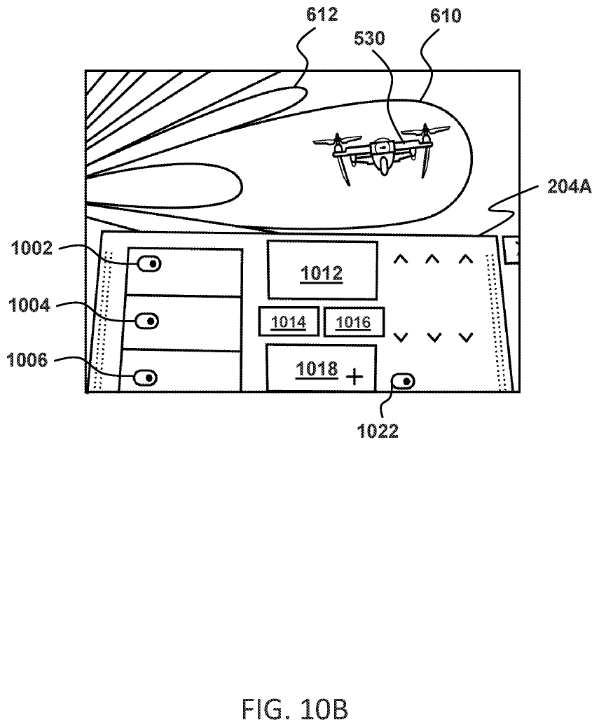

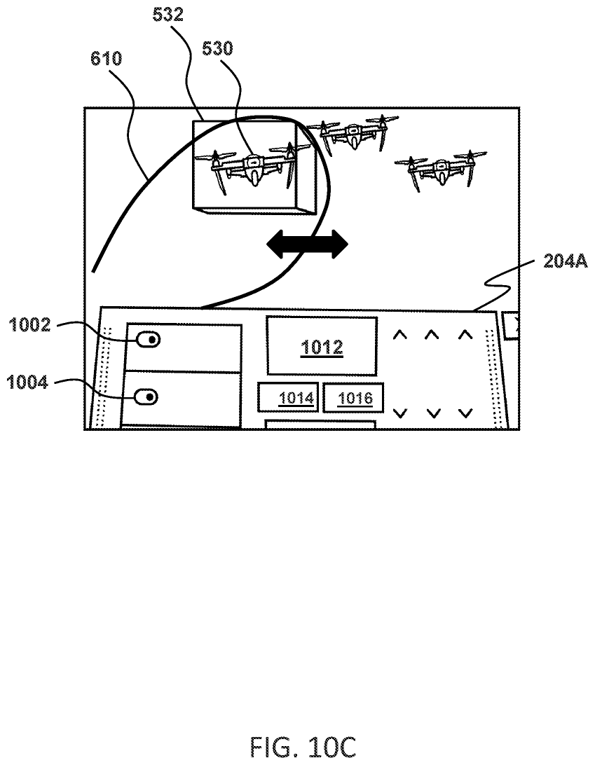

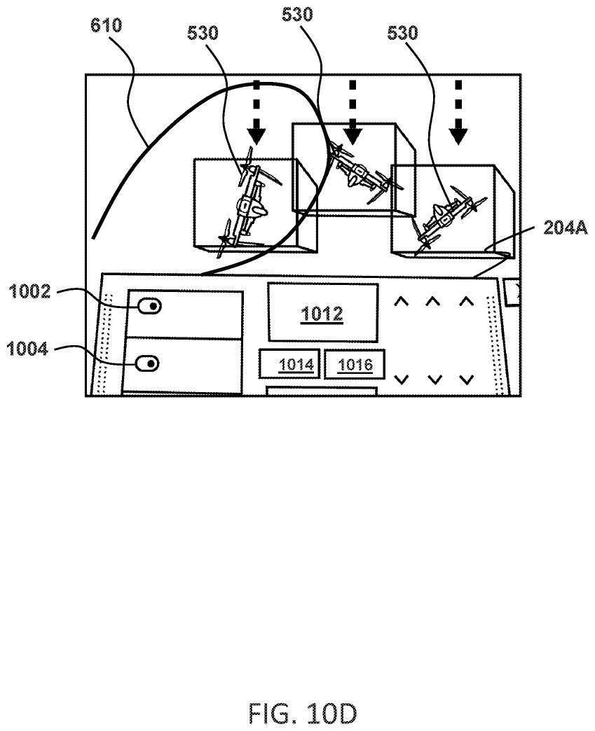

FIGS. 10A-10D illustrate controlling an emission device 201A with an AR device 204 to direct radiation to targets in accordance with certain aspects of the present disclosure. FIG. 10A depicts virtual control panel 204A displaying exemplary control information that may be activated by the user using hand gestures. Also, the user can similarly arrange the rendered GUIs having control information on the display of the AR device 204. Upon activating the control menu based on the user's command (gesture, voice, pressing a button, etc.), the GUI can show information related to the emission device 201A, or one or more control device 201B. A user can control such devices by selecting options displayed on the display of the AR device 204.

The example in FIG. 10A depicts a virtual control panel 204A that can provide options such as “outline target” 1002 “display target information” 1004, “display firing beam” 1006, etc. The virtual control panel can further display options related to various actions a user may want to take based on whether a target 530 is identified as to be affected by the emitted radiation. Examples of such control operations can be displayed in a menu on virtual control panel 204A, for example, “request fire” 1012, status information such as “approve” 1014 or “denied” 1016, or “fire” 1018. The virtual control panel 204A can further provide various options to toggle tracking information 1022 among various external devices and an option to change the position of the emission device 201A using virtual “up” and “down” keys displayed in the virtual control panel 204A.

FIG. 10B illustrates a rendering, on the AR device's display virtual control panel 204A similar to that shown in FIG. 10A, but including a rendering of radiation output (e.g., main lobe 610 and/or sidelobes 612) that is (or can be upon command) emitted from the emission device to affect targets (e.g., target 530). As seen in FIG. 10B, the user can view the real-time emission of radiation by the AR device, which may otherwise not be viewable directly by the human eye.

FIG. 10C illustrates a controlling the emission device to steer the radiation to deactivate a swarm of targets. For example, based on sensor information (e.g., from sensors 206) and image information (e.g., from imaging device 402), the hardware controller 212 can process the information using one or more software programs to determine information about the targets (e.g., identification, location, etc.). As shown in FIG. 10C, one identified target 530 can be depicted with second graphical indicator 532 that it is a target to be affected by the emitted radiation. The AR device can be utilized, e.g., via virtual control panel 204A, in communication with hardware controller 212, to control operations of the emission device to affect the swarm of targets. The virtual control panel 204A is also shown and depending on the placement of the virtual control panel 204A (which may be manipulated as described herein), the control menu may partially overlay the rendered radiation output. Similarly, if the virtual control panel 204A would be considered obstructing to a user, the control menu can be manipulated to be more out of the way of the rendered radiation output (including main lobe 610 and sidelobe 612) while still being wholly or partly in the field of view of the display device. In one exemplary embodiment, once a target 530 reaches a predetermined distance (e.g., a minimum range or an optimum range) to the emission device 201A or is within the area of effect of the radiation output, the emission device can release radiation based on the position of the target.

FIG. 10D illustrates an exemplary deactivation of targets 530. The depiction shows radiation output (including main lobe 610 and sidelobe 612) and the targets 530 descending in response to the deactivation caused by the radiation. Thus, the user can view, in real-time, the radiation as emitted from the emission device 201A and its effect on the target(s) 530. The radiation colors and rendered appearance may vary in different embodiments. For example, in some embodiments, different frequencies of radiation may be depicted with different colors. In some embodiments, the different radiation colors may be used to designate radiation having different waveform characteristics. To facilitate the visualization, the rendered radiation can change the color once the target(s) 530 are deactivated.

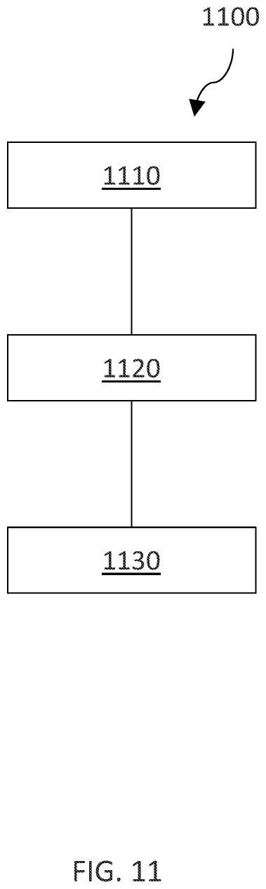

FIG. 11 is a simplified flow diagram depicting displaying information at an AR device and controlling an emission device. Any of the embodiments disclosed herein can be implemented as a process 1100 that can be implemented by one or more computers as part of one or more software modules or computer programs.

In one embodiment, at 1110, process 1100 can comprise displaying a virtual control panel 204A on the display, the virtual control panel 204A comprising a depicting of one or more targets.

At 1120, process 1100 can comprise rendering an output of an emission device 201A that is intended to be directed to the one or more targets.

At 1130, process 1100 can comprise controlling, by the user based on input received by user interaction with the virtual control panel 204A, one or more operations of the emission device 201A.

In the following, further features, characteristics, and exemplary technical solutions of the present disclosure will be described in terms of items that may be optionally claimed in any combination:

Item 1: A system comprising: an AR device having a display configured to display augmented, mixed, or virtual reality images to a user; at least one programmable processor; and a non-transitory machine-readable medium storing instructions which, when executed by the at least one programmable processor, cause the at least one programmable processor to perform operations comprising: displaying a virtual control panel on the display, the virtual control panel comprising a depicting of one or more targets; rendering an output of an emission device that is intended to be directed to the one or more targets; and controlling, by the user based on input received by user interaction with the virtual control panel, one or more operations of the emission device.

Item 2: The system of Item 1, wherein the rendering comprises regions of directed energy from the emission device.

Item 3: The system as in any one of the preceding Items, wherein the regions rendered comprise a main lobe and one or more sidelobes of the directed energy.

Item 4: The system as in any one of the preceding Items, the rendering comprising: obtaining emission device settings and/or static parameters of the emission device; calculating, with an emission simulator, a radiation field that will result from the emission device based at least on the emission device settings and/or the static parameters; and wherein the rendering includes displaying an intensity of electromagnetic fields associated with the output.

Item 5: The system as in any one of the preceding Items, the one or more operations of the emission device comprising controlling the emission device to emit the output to cause an effect on the one or more targets.

Item 6: The system as in any one of the preceding Items, the controlling based on the system interpreting one or more hand gestures, gaze or voice commands, button presses on the AR device or a control peripheral.

Item 7: The system as in any one of the preceding Items, wherein the rendering is updated based on the controlling of the emission device by the user.

Item 8: The system as in any one of the preceding Items, the one or more operations of the emission device comprising one or more of: positioning the emission device, selecting a type of output, setting a frequency of the output, setting an intensity of the output, setting a direction of the output, or setting a time to emit and steer the output to the one or more targets.

Item 9: The system as in any one of the preceding Items, the operations further comprising displaying an identification of the one or more targets on the display of the AR device, wherein the emitting of the output is based on an identification of the one or more targets.

Item 10: The system as in any one of the preceding Items, wherein the identification that is displayed comprises one or more of a type, size, attached components, direction of movement, brand, friendly classification or un-friendly classification.

Item 11: The system as in any one of the preceding Items, further comprising: obtaining map data of a region comprises the one or more targets; obtaining real-time target locations; and displaying a real-time overview on the display that comprises the map data and representations of the one or more targets.

Item 12: The system as in any one of the preceding Items, further comprising displaying coordinate information of one or more targets.

Item 13: The system as in any one of the preceding Items, wherein the coordinate information comprises one or more of latitude, longitude, or elevation of a target.

Item 14: The system as in any one of the preceding Items, wherein the coordinate information is obtained from GPS, RADAR, or LIDAR data.

Item 15: The system as in any one of the preceding Items, wherein the coordinate information is obtained from a coordinate information of the one or more targets with respect to a scout UAV.

Item 16: The system as in any one of the preceding Items, wherein the coordinate information obtained from the coordinate information of the one or more targets with respect to the scout UAV is merged with coordinate information obtained from GPS, RADAR, or LIDAR data.

Item 17: The system as in any one of the preceding Items, further comprising: a sensor configured to detect one or more attributes of the one or more targets; and an imaging device configured to image the one or more targets; the operations further comprising: obtaining, from the sensor, real-time sensor data and/or real-time image data; and identifying, from the real-time sensor data and/or the real-time image data, the target.

Item 18: The system as in any one of the preceding Items, wherein the detected one or more attributes of the one or more targets comprises: presence, environmental data at or around the one or more targets, velocity, acceleration, or coordinates.

Item 19: The system as in any one of the preceding Items, wherein imaging of the one or more targets comprises imaging one or more of: the one or more targets itself, attached components, or emissions.

Item 20: The system as in any one of the preceding Items, the operations further comprising identifying information about the one or more targets based on the sensor data, the information comprising one or more of: presence, velocity, acceleration, coordinates, route navigated, satellite source, range from the emission device, environmental data around the one or more targets, temperature, or field of view (FOV).

Item 21: The system as in any one of the preceding Items, the operations further comprising identifying information about the one or more targets based on the image data, the information comprising one or more of: identifying a type of target, identifying one or more characteristics, identifying one or more devices or systems associated with the one or more targets, battery information, power information, type, brand, size, or shape.

Item 22: A non-transitory machine-readable medium storing instructions which, when executed by at least one programmable processor, cause the at least one programmable processor to perform operations comprising those in any one of the preceding Items.

One or more aspects or features of the subject matter described herein can be realized in digital electronic circuitry, integrated circuitry, especially designed application specific integrated circuits (ASICs), field programmable gate arrays (FPGAs) computer hardware, firmware, software, and/or combinations thereof. These various aspects or features can comprise implementation in one or more computer programs that are executable and/or interpretable on a programmable system comprising at least one programmable processor, which can be special or general purpose, coupled to receive data and instructions from, and to transmit data and instructions to, a storage system, at least one input device, and at least one output device. The programmable system or computing system may comprise clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, comprises machine instructions for a programmable processor, and can be implemented in a high-level procedural language, an object-oriented programming language, a functional programming language, a logical programming language, and/or in assembly/machine language. As used herein, the term “machine-readable medium” (or “computer readable medium”) refers to any computer program product, apparatus and/or device, such as for example magnetic discs, optical disks, memory, and Programmable Logic Devices (PLDs), used to provide machine instructions and/or data to a programmable processor, comprising a machine-readable medium that receives machine instructions as a machine-readable signal. The term “machine-readable signal” (or “computer readable signal”) refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices comprise, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, computer programs and/or articles depending on the desired configuration. Any methods or the logic flows depicted in the accompanying figures and/or described herein do not necessarily require the particular order shown, or sequential order, to achieve desirable results. The implementations set forth in the foregoing description do not represent all implementations consistent with the subject matter described herein. Instead, they are merely some examples consistent with aspects related to the described subject matter. Although a few variations have been described in detail above, other modifications or additions are possible. Further features and/or variations can be provided in addition to those set forth herein. The implementations described above can be directed to various combinations and sub combinations of the disclosed features and/or combinations and sub combinations of further features noted above. Furthermore, above-described advantages are not intended to limit the application of any issued claims to processes and structures accomplishing any or all of the advantages.

Additionally, section headings shall not limit or characterize the invention(s) set out in any claims that may issue from this disclosure. Further, the description of a technology in the “Background” is not to be construed as an admission that technology is prior art to any invention(s) in this disclosure. Neither is the “Summary” to be considered as a characterization of the invention(s) set forth in issued claims. Furthermore, any reference to this disclosure in general or use of the word “invention” in the singular is not intended to imply any limitation on the scope of the claims set forth below. Multiple inventions may be set forth according to the limitations of the multiple claims issuing from this disclosure, and such claims accordingly define the invention(s), and their equivalents, that are protected thereby.

1. A system comprising:
a device having a display configured to display augmented reality, mixed reality, or virtual reality images to a user;
at least one programmable processor; and
a non-transitory machine-readable medium storing instructions which, when executed by the at least one programmable processor, cause the at least one programmable processor to:
display a virtual control panel on the display, the virtual control panel comprising a depicting of one or more targets;
render an output of an emission device configured to be directed to the one or more targets; and
control, as a result of input received by user interaction with the virtual control panel, one or more operations of the emission device.

2. The system of claim 1, wherein execution of the instructions causes the at least one programmable processor to:
render representations of regions of directed energy from the emission device.

3. The system of claim 2, wherein the regions rendered comprise a main lobe and one or more sidelobes of the directed energy.

4. The system of claim 2, wherein execution of the instructions causes the at least one programmable processor to:
obtain emission device settings or static parameters of the emission device;
calculate, with an emission simulator, a radiation field that will result from the emission device based at least on the emission device settings or the static parameters; and
display an intensity of electromagnetic fields associated with the output.

5. The system of claim 1, wherein execution of the instructions causes the at least one programmable processor to:
control the emission device to emit the output to cause an effect on the one or more targets.

6. The system of claim 1, wherein execution of the instructions causes the at least one programmable processor to:
control the one or more operations based on one or more hand gestures, gaze commands, voice commands, button presses on the device, or inputs to a control peripheral of the device.

7. The system of claim 1, wherein execution of the instructions causes the at least one programmable processor to:
update the output rendered based on the control of the emission device by the user.

8. The system of claim 1, the one or more operations of the emission device comprising one or more of: positioning the emission device, selecting a type of output, setting a frequency of the output, setting an intensity of the output, setting a direction of the output, or setting a time to emit and steer the output to the one or more targets.

9. The system of claim 1, wherein execution of the instructions causes the at least one programmable processor to:
display an identification of the one or more targets on the display of the AR device, wherein the output is emitted based on an identification of the one or more targets.

10. The system of claim 9, wherein the identification that is displayed comprises one or more of an indication of a type, size, attached components, direction of movement, brand, friendly classification or un-friendly classification.

11. The system of claim 1, wherein execution of the instructions causes the at least one programmable processor to:
obtain map data of a region that includes the one or more targets;
obtain real-time target locations of the one or more targets; and
display a real-time overview on the display that comprises the map data and representations of the one or more targets.

12. The system of claim 1, wherein execution of the instructions causes the at least one programmable processor to:
display coordinate information of the one or more targets.

13. The system of claim 12, wherein the coordinate information comprises one or more of latitude, longitude, or elevation of a target.

14. The system of claim 13, wherein the coordinate information is obtained from a GPS, a RADAR device, or a LIDAR device.

15. The system of claim 13, wherein the coordinate information is obtained from coordinate information of the one or more targets with respect to a scout Unmanned Aerial Vehicle (UAV).

16. The system of claim 15, wherein the coordinate information obtained of the one or more targets with respect to the scout UAV is merged with coordinate information obtained from a GPS, a RADAR device, or a LIDAR device.

17. The system of claim 1, further comprising:
a sensor configured to detect one or more attributes of the one or more targets; and
an imaging device configured to image the one or more targets, wherein execution of the instructions causes the at least one programmable processor to:
obtain, from the sensor, real-time sensor data or real-time image data; and
identify, from the real-time sensor data or the real-time image data, a target.

18. The system of claim 17, wherein the detected one or more attributes of the one or more targets comprises: presence, environmental data at or around the one or more targets, velocity, acceleration, or coordinates.

19. The system of claim 17, wherein the imaging device is configured to image one or more of: the one or more targets itself, attached components, or emissions.

20. The system of claim 17, wherein execution of the instructions causes the at least one programmable processor to:
identify information about the one or more targets based on the sensor data, the information comprising one or more of: presence, velocity, acceleration, coordinates, route navigated, satellite source, range from the emission device, environmental data around the one or more targets, temperature, or field of view (FOV).

21. The system of claim 17, wherein execution of the instructions causes the at least one programmable processor to:
identify information about the one or more targets based on the image data, the information comprising one or more of: a type of target, one or more characteristics, one or more devices or systems associated with the one or more targets, battery information, power information, type, brand, size, or shape.

22. A non-transitory machine-readable medium storing instructions which, when executed by at least one programmable processor, cause the at least one programmable processor to:
display a virtual control panel on a display, the virtual control panel comprising a depicting of one or more targets;
render an output of an emission device configured to be directed to the one or more targets; and
control, as a result of input received by user interaction with the virtual control panel, one or more operations of the emission device.
